(19) United States
(12) Patent Application Publication
(10) Pub. No.: US 2024/0349194 A1
(43) Pub. Date: Oct. 17, 2024

(54) WIRELESS TELECOMMUNICATIONS APPARATUSES AND METHODS

(71) Applicant: Sony Group Corporation, Tokyo (JP)

(72) Inventors: Basuki PRIYANTO, Basingstoke (GB); Martin Warwick BEALE, Basingstoke (GB); Shin Horng WONG, Basingstoke (GB)

(73) Assignee: Sony Group Corporation, Tokyo (JP)

(21) Appl. No.: 18/683,252

(22) PCT Filed: Jul. 25, 2022
(86) PCT No.: PCT/EP2022/070765

§ 371 Date: Feb. 13, 2024

(30) Foreign Application Priority Data
Aug. 23, 2021 (EP) 21192679.5

(51) Int. Cl. H04W 52/02; H04W 76/27

(52) U.S. Cl. CPC H04W 52/0261; H04W 76/27

(57) ABSTRACT

A first wireless telecommunications apparatus comprising: communication circuitry configured to receive wireless signals from or transmit wireless signals to a second wireless telecommunications apparatus, the communication circuitry using energy stored in an energy storage device to receive or transmit the wireless signals; and control circuitry configured to: control the communication circuitry to suspend the receiving of wireless signals from or transmitting of wireless signals to the second wireless telecommunications apparatus during a time period when there is insufficient energy in the energy storage device usable by the communication circuitry; and control the communication circuitry to resume the receiving of wireless signals from or transmitting of wireless signals to the second wireless telecommunications apparatus after a time period of accumulating sufficient energy in the energy storage device usable by the communication circuitry.

### BACKGROUND

### Field of the Disclosure

The present disclosure relates to wireless telecommunications apparatuses and methods.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

Recent generation mobile telecommunication systems, such as those based on the 3rd Generation Partnership Project (3GPP (RTM)) defined Universal Mobile Telecommunications System (UMTS), Long Term Evolution (LTE) and 5G New Radio (NR) architectures, are able to support a wider range of services than simple voice and messaging services offered by previous generations of mobile telecommunication systems. For example, with the improved radio interface and enhanced data rates provided by LTE and NR systems, a user can experience high data rate applications such as mobile video streaming and mobile video conferencing that would previously only have been available via a fixed line data connection. In addition to supporting these kinds of more sophisticated services and devices, it is also proposed for newer generation mobile telecommunication systems such as NR to support less complex services and devices which make use of the reliable and wide ranging coverage of newer generation mobile telecommunication systems without necessarily needing to rely on the high data rates available in such systems. For example, a less complex device may be a tiny device equipped with sensors and a small battery capacity. Such a less complex device needs to transmit the sensor data at a typically infrequent and/or low data rate.

The demand to deploy such networks is therefore strong and the coverage area of these networks, i.e. geographic locations where access to the networks is possible, may be expected to increase ever more rapidly. There is also a continuing need to improve the network speed, reliability, efficiency and/or flexibility of these networks. In particular, there is a need to ensure entities of a network are provided with sufficient energy to communicate with the network, are able to use that energy efficiently, and are able to use radio resources efficiently.

### SUMMARY

The present disclosure is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 schematically represents some elements of an LTE-type wireless telecommunications system;

FIG. 2 schematically represents some elements of an NR-type wireless telecommunications system;

FIG. 3 schematically represents some components of the wireless telecommunications system shown in FIG. 2 in more detail;

FIG. 4 schematically further represents some elements of an NR-type wireless telecommunications system;

FIG. 5 schematically represents energy flows on a device using harvested energy;

FIG. 6 schematically represents an energy harvesting gap;

FIG. 7 schematically represents a connected mode energy harvesting gap operation;

FIG. 8 schematically represents a wireless signaling operation to enable energy harvesting;

FIG. 9 shows a first example method of controlling a wireless telecommunications apparatus; and

FIG. 10 shows a second example method of controlling a wireless telecommunications apparatus.

Like reference numerals designate identical or corresponding parts throughout the drawings.

### DETAILED DESCRIPTION OF THE EMBODIMENTS

### Long Term Evolution (LTE) Wireless Communications System

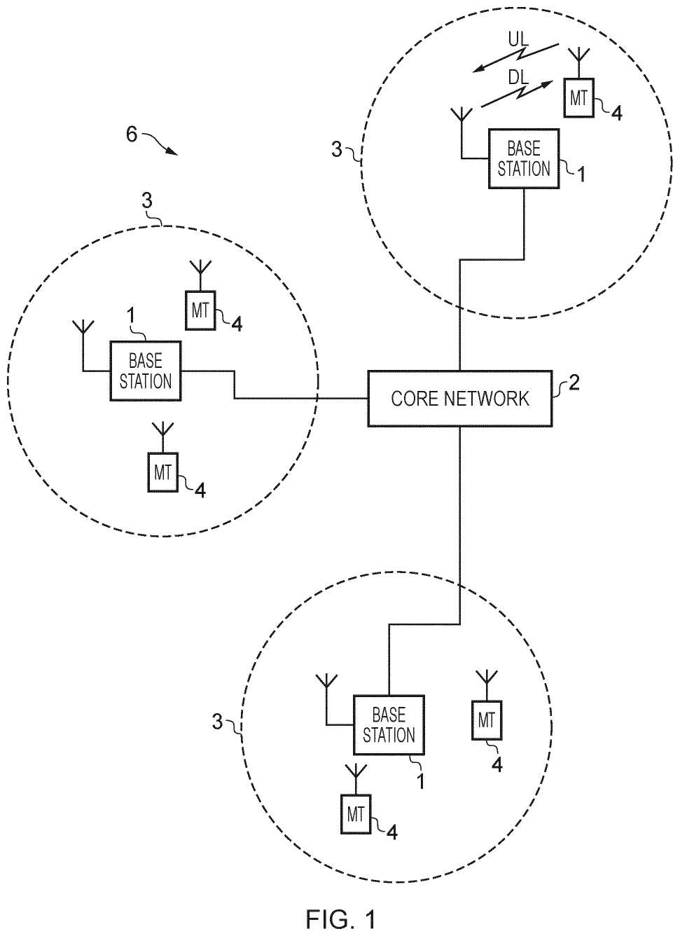

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2. Each base station provides a coverage area 3 (i.e. a cell) within which data can be communicated to and from communications devices 4.

Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink. Data is transmitted from communications devices 4 to the base stations 1 via a radio uplink. The core network 2 routes data to and from the communications devices 4 via the respective base stations 1 and provides functions such as authentication, mobility management, charging and so on. A communications device may also be referred to as a mobile station, user equipment (UE), user terminal, mobile radio, terminal device and so forth.

Services provided by the core network 2 may include connectivity to the internet or to external telephony services. The core network 2 may further track the location of the communications devices 4 so that it can efficiently contact (i.e. page) the communications devices 4 for transmitting downlink data towards the communications devices 4.

A base station which is an example of network infrastructure equipment, may also be referred to as a transceiver station, nodeB, e-nodeB, eNB, g-nodeB, gNB and so forth (note g-nodeB and gNB are related to 5G New Radio-see below). In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

In the present disclosure, any apparatus (e.g. communications device, infrastructure equipment and the like) which transmits and/or receives wireless telecommunications signals in any of the exemplified wireless telecommunication networks/systems may be referred to generally as a wireless telecommunications apparatus.

### 5G New Radio (NR) Wireless Communications System

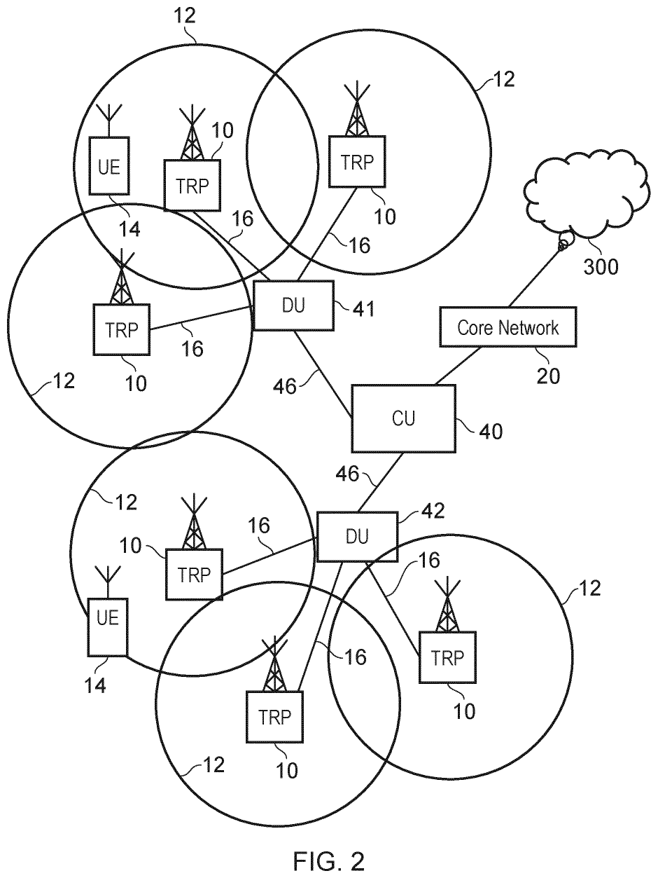

An example configuration of a wireless communications network which uses some of the terminology proposed for NR is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to a core network 20 which may contain all other functions required for communicating data to and from the wireless communications devices and the core network 20. The core network 20 may be connected to other networks 300.

The elements of the wireless access network shown in FIG. 2 may operate in a similar way to corresponding elements of an LTE network as described with regard to the example of FIG. 1. It will be appreciated that operational aspects of the telecommunications network represented in FIG. 2 and of other networks discussed herein in accordance with embodiments of the disclosure which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated, therefore, that operational aspects of an NR network (for example in relation to specific communication protocols and physical channels for communicating between different elements) may be different to those known from LTE or other known mobile telecommunications standards. However, it will also be appreciated that each of the core network component, base stations and communications devices of an NR network will be functionally similar to, respectively, the core network component, base stations and communications devices of an LTE wireless communications network.

In terms of broad top-level functionality, the core network 20 connected to the NR telecommunications system represented in FIG. 2 may be broadly considered to correspond with the core network 2 represented in FIG. 1, and the central unit 40 and associated DUs 41, 42/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the CU 40, DUs 41, 42 and/or TRPs 10. Communications devices 14 are represented in FIG. 2 within the coverage area of respective communication cells 12. These communications devices 14 may thus exchange signalling with the CU 40 via the TRP 10 associated with their respective communications cells 12.

It will further be appreciated that FIG. 2 represents merely one example of a proposed architecture for an NR-based telecommunications system in which approaches in accordance with the principles described herein may be adopted, and the functionality disclosed herein may also be applied in respect of wireless telecommunications systems having different architectures.

Thus certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a CU 40, DU 41, 42 and/or TRP 10 of the kind shown in FIG. 2 which is adapted to provide functionality in accordance with the principles described.

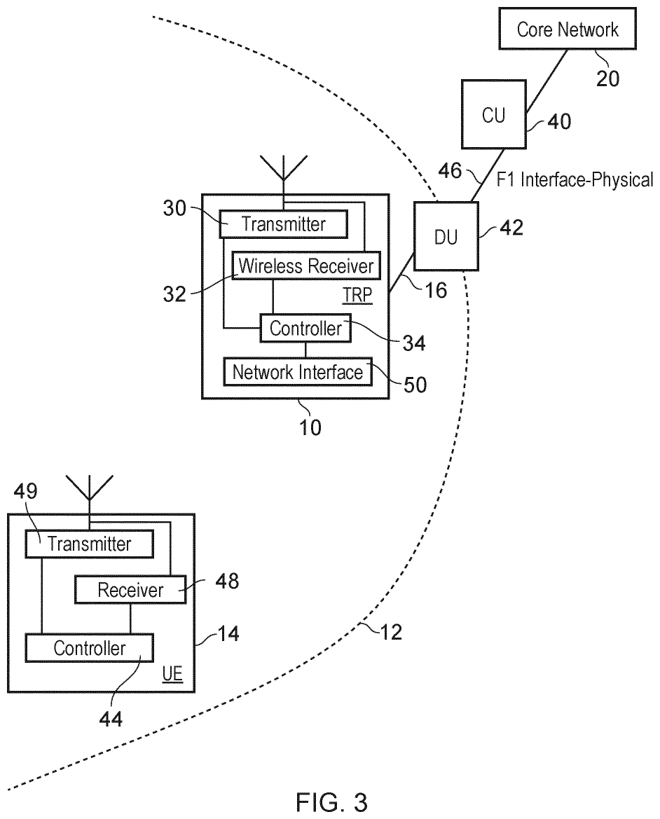

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which is configured to control the transmitter 30 and the receiver 32 to transmit radio signals to and receive radio signals from one or more UEs 14 within a cell 12 formed by the TRP 10. As shown in FIG. 3, an example UE 14 is shown to include a corresponding wireless transmitter 49, wireless receiver 48 and a controller or controlling processor 44 which is configured to control the transmitter 49 to transmit signals representing uplink data to the wireless communications network via the wireless access interface formed by the TRP 10 and the receiver 48 to receive downlink data as signals transmitted by the transmitter 30 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance, for example, with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with specifications 3GPP TS 38.470 and 3GPP TS 38.473 and, for example, may be formed from a fibre optic or other wired high bandwidth connection. In one example, the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

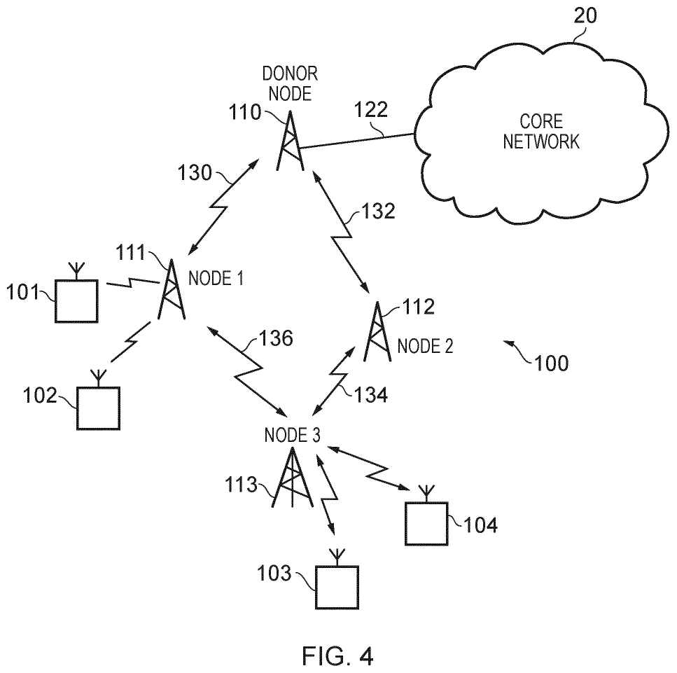

Example arrangements of the present technique can be formed from a wireless communications network corresponding to that shown in FIG. 1 or 2, as shown in FIG. 4. FIG. 4 provides an example in which cells of a wireless communications network are formed from infrastructure equipment which are provided with an Integrated Access and Backhaul (IAB) capability. The wireless communications network 100 comprises the core network 20 and a first, a second, a third and a fourth communications device (respectively 101, 102, 103 and 104) which may broadly correspond to the communications devices 4, 14 described above.

The wireless communications network 100 comprises a radio access network, comprising a first infrastructure equipment 110, a second infrastructure equipment 111, a third infrastructure equipment 112, and a fourth infrastructure equipment 113. Each of the infrastructure equipment provides a coverage area (i.e. a cell, not shown in FIG. 4) within which data can be communicated to and from the communications devices 101 to 104. For example, the fourth infrastructure equipment 113 provides a cell in which the third and fourth communications devices 103 and 104 may obtain service. Data is transmitted from the fourth infrastructure equipment 113 to the fourth communications device 104 within its respective coverage area (not shown) via a radio downlink. Data is transmitted from the fourth communications device 104 to the fourth infrastructure equipment 113 via a radio uplink.

The infrastructure equipment 110 to 113 in FIG. 4 may correspond broadly to the TRPs 10 of FIG. 2 and FIG. 3.

The first infrastructure equipment 110 in FIG. 4 is connected to the core network 20 by means of one or a series of physical connections. The first infrastructure equipment 110 may comprise a TRP 10 having the physical connection 16 to the DU 42 in combination with the DU 42 having the physical connection to the CU 40 by means of the F1 interface 46. The CU 40, in turn, is connected by means of a physical connection (e.g. fibre optic) to the core network 20.

However, there is no direct physical connection between any of the second infrastructure equipment 111, the third infrastructure equipment 112, and the fourth infrastructure equipment 113 and the core network 20. As such, it may be necessary or otherwise determined to be appropriate for data received from a communications device (i.e. uplink data) or data for transmission to a communications device (i.e. downlink data) to be transmitted to or from the core network 20 via other infrastructure equipment, such as the first infrastructure equipment 110, which has a physical connection to the core network 20, even if the communications device is not currently served by the first infrastructure equipment 110 but is, for example, in the case of the wireless communications device 104, served by the fourth infrastructure equipment 113.

The second, third and fourth infrastructure equipment 111 to 113 in FIG. 4 may each comprise a TRP, broadly similar in functionality to the TRPs 10 of FIG. 2.

In some arrangements of the present technique, one or more of the second to fourth infrastructure equipment 111 to 113 in FIG. 4 may further comprise a DU 42, and in some arrangements of the present technique, one or more of the second to fourth infrastructure equipment 110 to 113 may comprise a DU and a CU.

In some arrangements of the present technique, the CU 40 associated with the first infrastructure equipment 110 may perform the function of a CU not only in respect of the first infrastructure equipment 110, but also in respect of one or more of the second, the third and the fourth infrastructure equipment 111 to 113.

In order to provide the transmission of the uplink data or the downlink data between a communications device and the core network, a route is determined by any suitable means, with one end of the route being an infrastructure equipment physically connected to a core network and by which uplink and downlink traffic is routed to or from the core network.

In the following, the term ‘node’ is used to refer to an entity or infrastructure equipment which forms a part of a route for the transmission of the uplink data or the downlink data.

An infrastructure equipment, which is physically connected to the core network and operated in accordance with an example arrangement may provide communications resources to other infrastructure equipment and so is referred to as a ‘donor node’. An infrastructure equipment which acts as an intermediate node (i.e. one which forms a part of the route but is not acting as a donor node) is referred to as a ‘relay node’. It should be noted that although such intermediate node infrastructure equipment acts as relay nodes on the backhaul link, they may also provide service to communications devices. The relay node at the end of the route which is the infrastructure equipment controlling the cell in which the communications device is obtaining service is referred to as an ‘end node’.

Hence, for clarity and conciseness in the following description, the first infrastructure equipment 110 is referred to below as the ‘donor node’, the second infrastructure equipment 111 is referred to below as ‘Node 1’, the third infrastructure equipment 112 is referred to below as ‘Node 2’ and the fourth infrastructure equipment 113 is referred to below as ‘Node 3’.

For the purposes of the present disclosure, the term ‘upstream node’ is used to refer to a node acting as a relay node or a donor node in a route which is a next hop when used for the transmission of data via that route from a wireless communications device to a core network. That is, ‘upstream node’ is used to refer to a relay node or a donor node to which uplink data is transmitted for transmission to a core network. Similarly, ‘downstream node’ is used to refer to a relay node from which uplink data is received for transmission to a core network. For example, if uplink data is transmitted via a route comprising (in order) the Node 3 113, the Node 1 111 and the donor node 110, then the donor node 110 is an upstream node with respect to the Node 1 111, and the Node 3 113 is a downstream node with respect to the Node 1 111.

More than one route may be used for the transmission of the uplink/downlink data from/to a given communications device. This is referred to as ‘multi-connectivity’. For example, the uplink data transmitted by the wireless communications device 104 may be transmitted either via the Node 3 113 and the Node 2 112 to the donor node 110, or via the Node 3 113 and the Node 1 111 to the donor node 110.

The donor node 110 and the second to fourth infrastructure equipment acting as the Nodes 1 to 3 111, 112, 113 may communicate with one or more other nodes by means of one or more inter-node wireless communications links (which may also be referred to “wireless backhaul communications links”). For example, FIG. 4 illustrates four inter-node wireless communications links 130, 132, 134, 136.

Each of the inter-node wireless communications links 130, 132, 134, 136 may be provided by means of a respective wireless access interface. Alternatively, two or more of the inter-node wireless communications links 130, 132, 134, 136 may be provided by means of a common wireless access interface and, in particular, in some arrangements of the present technique, all of the inter-node wireless communications links 130, 132, 134, 136 are provided by a shared wireless access interface.

A wireless access interface, which provides an inter-node wireless communications link, may also be used for communications between an infrastructure equipment and a communications device which is served by the infrastructure equipment. For example, the fourth wireless communications device 104 may communicate with the Node 3 113 using the wireless access interface which provides the inter-node wireless communications link 134 connecting the Node 3 113 and the Node 2 112.

The wireless access interface(s) providing the inter-node wireless communications links 130, 132, 134, 136 may operate according to any appropriate specifications and techniques.

Examples of wireless access interface standards include the 3GPP-specified General Packet Radio Service (GPRS)/Enhanced Data rates for Global Evolution (EDGE) (“2G”), Wideband Code-Division Multiple Access (WCDMA)/Universal Mobile Telecommunications System (UMTS) and related standards such as High Speed Packet Access (HSPA) and HSPA+ (“3G”), LTE and related standards including LTE-Advanced (LTE-A) (“4G”), and NR and related standards including NR-Advanced (“5G”). Techniques that may be used to provide a wireless access interface include one or more of time-division multiple access (TDMA), frequency-division multiple access (FDMA), orthogonal frequency-division multiple access (OFDMA), single-carrier frequency-division multiple access (SC-FDMA), code-division multiple access (CDMA). Duplexing (i.e. the transmission over a wireless link in two directions) may be by means of frequency division duplexing (FDD) or time division duplexing (TDD) or a combination of both.

In some arrangements of the present technique, two or more of the inter-node wireless communications links 130, 132, 134, 136 may share communications resources. This may be because two or more of the inter-node wireless communications links 130, 132, 134, 136 are provided by means of a single wireless access interface or because two or more of the inter-node wireless communications links 130, 132, 134, 136 nevertheless operate simultaneously using a common range of frequencies. The nature of the inter-node wireless communications links 130, 132, 134, 136 may depend on the architecture by which the wireless backhaul functionality is achieved.

As networks develop, there is a need to ensure entities of a network are provided with sufficient energy to communicate with the network and are able to use that energy efficiently. This is particularly true for UEs.

There are various proposals to enhance UE power saving. One of these enhancements is a “zero” power UE, where the UE can harvest energy to power its communication with the gNB. For example, the energy can be harvested from ambient harvestable energy sources such as solar, wind, vibration, piezoelectric, wave action, tidal action, etc. or even from incident radio frequency (RF) energy.

### RF Incident Energy

Some of the proposals consider that energy is harvested from the incident radio frequency (RF) wave. Harvesting energy based on the incident RF energy has several advantages and disadvantages.

An advantage is the RF energy is always available. Hence the UE can always be awake while being powered from this energy.

A disadvantage is the received power of the RF energy source is typically low. A receiver operating on such energy typically requires a power level of-20 dBm for operation, which is not consistent with the low amounts of received power that are typically available.

Another disadvantage is the transmission power level of a device that is powered by an RF energy source is typically very low. Such devices may operate based on backscattering technology, for example. The backscattered signal is created at the same carrier frequency as the incident RF energy. It is thus hard for the source of the RF energy (e.g. a gNB) to differentiate between the transmitted RF signal and the backscattered signal.

Another disadvantage is that, to reduce the power consumption of a receiver that operates on incident RF energy, a new waveform/signaling scheme is typically required. For example, an on-off keying (OOK) signaling scheme may be used for such lower power communications. There are then issues of multiplexing this new signaling scheme with the currently supported orthogonal frequency-division multiplexing (OFDM) and SC-FDMA waveforms.

### Ambient Energy

Since there are multiple disadvantages to operating on incident RF energy, it can be desirable to operate based on ambient harvested energy. There are multiple forms of ambient harvestable energy, including solar, wind, vibration, piezoelectric, wave action, tidal action, etc.

A problem with operating on some forms of ambient energy is its unpredictability. Both the available power of ambient energy and whether the ambient energy source exists or not are unpredictable. For example, the available power of wind energy depends on the wind speed. On windless days, wind energy is not available.

Some aspects of ambient energy are predictable. For example, it is known that solar energy is available between sunrise and sunset and that the amount of solar energy depends on the elevation angle of the sun relative to the solar power harvesting device. The amount of harvestable energy may still vary however (for example, depending on cloud cover). It is also known that there are times at which this energy source is unavailable, for example during hours of darkness.

Devices can store harvested energy using, for example, batteries, capacitors or supercapacitors. Energy storage technologies can be characterized by, amongst other things, the amount of charge and/or energy which is storable, the rate at which charge can be stored on the device and/or the rate at which charge can be extracted from the device.

Devices operating on ambient energy can store that energy and can then use that energy to drive a modem operating with a standard waveform (such as an LTE or NR waveform). However, compared to a device operating on a conventional power source (for example, a conventional battery charged using mains electricity), the energy stored in the storage device will be rapidly depleted. The energy storage device here can be, for example, a small battery, capacitor(s) or supercapacitor(s) in which the capacity is relatively smaller than the capacity of a conventional battery. A device operating on ambient harvested energy may hence be unable to sustain a wireless connection to a network for a substantial period of time and the time for which it can sustain a connection may vary depending on conditions and the energy harvesting source. In particular, during the energy harvesting period, the device may not be able to maintain communication with the network (e.g. via a gNB). Frequent transitions between connected and disconnected operation require frequent unnecessary/repeated signalling over the network, thus increasing signalling overhead. There is a need to address this problem.

An energy storage device of the present disclosure may thus be described as a low capacity energy storage device because the amount of energy it is able to store (e.g. from ambient harvested energy) is lower than that of a conventional energy storage device charged by physically connecting the conventional energy storage device to an electricity supply (such as a mains or vehicle electricity supply).

In the present disclosure, the network is aware of the UE energy harvesting operation and controls the UE behavior by providing energy harvesting gap periods based on UE assistance data. Enabling such operation helps alleviate unnecessary signalling between the UE and gNB.

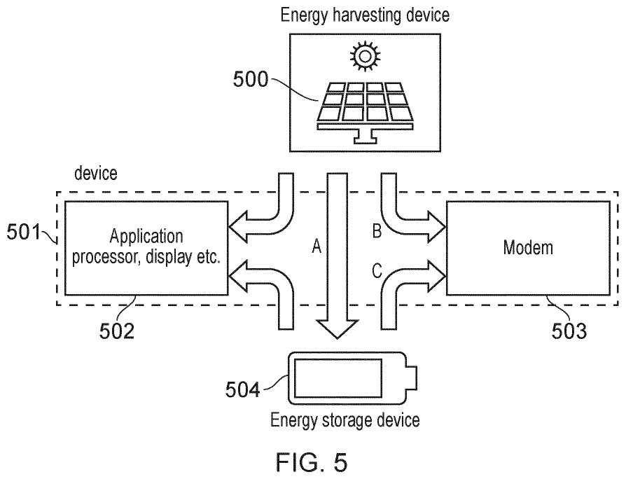

FIG. 5 shows the energy flows on a device 501 operating according to harvested energy. The device consists of a modem 503, which supports communication with a base station and other parts 502 of the device 501, which include an application processor, display, etc. An energy harvesting device 500 is connected to the device. This energy harvesting device converts ambient energy (such as solar radiation) into electrical energy. The device is also connected to an energy storage device 504, such as a small battery or large capacitor. While the energy harvesting device 500 and energy storage device 504 are shown as being separate entities to the rest of the device, in some implementations, these devices and/or any other components shown in FIG. 5 may be integrated into a single device. The device 501 may be an example of the UE 14, for example. In this case, the transmitter 49 and receiver 48 are comprised within the modem 503 and the controller 44 is comprised within the modem 503 or other parts 502, for example.

The energy harvesting device 500 generates electrical energy. This energy can be stored on the energy storage device 504 via direct transfer of energy along route “A”. The energy harvesting device can also directly power the modem 503 via route “B”. If there is a large amount of ambient power, the energy harvesting device can simultaneously power the modem (via route “B”) and store excess energy in the energy storage device (via route “A”). If there is insufficient power (for example when the modem uses a lot of power or when the energy harvesting device is generating little electrical power due to there being little ambient power), the energy storage device provides power to the modem (via route “C”). This power to the modem can be supplemented by power flowing directly from the energy harvesting device to the modem. The power flows shown in FIG. 5 can be controlled via a power management device (included in the other parts 502—in one example, when the device 501 is an example of the UE 14, the power management device may be part of the controller 44). FIG. 5 also shows that the energy harvesting device 500 and/or energy storage device 504 may also provide power to the other parts 502.

Some example values for the amount of power that can be harvested by various energy harvesting techniques are given in Table 1. This table is taken from [2]. For a solar panel with an area of 1 cm², an electrical power of approximately 10 mW could harvested, based on this table.

TABLE 1
TABLE III: Typical energy harvesting sources and techniques used in EH-IoTs.

| Source | Transduction | Signal | Principle | Requirement | Energy Density |
|---|---|---|---|---|---|
| Kinetic | Piezoelectric | AC | Apply compression on crystalline materials | Motions or | Walking: 49 μW/cm²@3 km/h, |
| | Electromagnetic | AC | Change of magnetic field under movement | vibrations | piezoelectric EH, knee bending [25] |
| | Electrostatic | AC | Change of electrical field under movement | | Wind: 370 μW/cm²@15 m/s, |
| | Triboelectric | AC | Frictional contact of two different materials | | triboelectric EH [26] |
| Thermal | Thermoelectric | DC | Spatial temperature gradient | Temperature | 14 uW/cm² on human wrist, |
| | Pyroelectric | AC | Temporal temperature difference | difference | thermoelectric EH [27] |
| Solar | Photovoltaic | DC | Convert light into electricity | Bright | Transparent: 7 mW/cm²@128klux [28] |
| | | | | environment | Opaque: 26.7 mW/cm²@128klux [29] |
| | | | | | Opaque: 16 μW/cm²@400lux [30] |
| RF | RF radiation | AC | Convert electromagnetic wave into electricity | Radio | TV tower: 60 μW@distance 4.1 km (31] |
| | | | | coverage | Wi-Fi: 100 μW@distance 2 feet [32] |

As an example of a device 501, a New Radio (NR) UE with reduced capability, known as NR RedCap UE, is currently being introduced in 3GPP Rel-17. A UE that can perform energy harvesting is considered as a new feature as part of the enhanced NR RedCap in the upcoming 3GPP Rel-18. The UE can be equipped with an energy storage device 504 such as a small battery and, additionally, the UE can perform self-charging by harvesting the energy to power its communication with the gNB.

In another example, an NR Internet of Things (IoT) UE with such an energy harvesting feature could enable some new use-cases, for example in the area of industrial/factory automation. In such scenarios, the device is expected to operate with frequent transmission of small amounts of data (e.g. sensor data) and operate with a small battery. Hence, the energy harvesting time period can be relatively small.

In another example, some more advanced UE applications require a significant amount of data communication (such as the transmission of images or video) and the energy required to transmit the data during the length of a connection may be greater than the energy stored in the device. A break during transmission is therefore required for harvesting energy to finish the transmission.

In a legacy UE device, when the power level is low, the device is expected to be manually charged. The device power level is thus fully controllable by the user (e.g. the user can decide when to charge the device). When the device has full power, the device may be in connected mode to maintain communication with the network. When there is no power, the device will be disconnected from the network. When the device has been manually charged, the device needs to initiate signaling so that it can once again enter connected mode. The device needs to perform multiple steps to enter a connected mode. After the power ON, the device performs synchronization, obtains system information, performs RRC connection signaling and then enters RRC connected mode. These operations may require excessive signaling and consume extra energy. An advantage of being in connected mode is that the UE can be communicated to with low latency and low signaling requirements.

On the other hand, a UE device (such as an NR RedCap UE) which uses energy harvesting is expected to be able to charge autonomously. For example, the device may be placed in a location where it is difficult to perform manual charging. The device may also have a small battery capacity so that its power source may be ON and OFF frequently (as the battery is frequently charged using energy harvesting and then discharged to perform communications with the network). In a conventional setting, this requires frequent switching between connected mode and disconnected mode and the signaling required for this results in significant network overhead.

To address this problem, in the present disclosure, the gNB is aware of when the UE is performing battery charging. During charging, data transmission between the UE and gNB does not occur and, once the UE has performed the charging and has sufficient charge, data transmission between the UE and gNB occurs again. Throughout the charging (when the UE harvests and stores energy and there is no data transmission) and non-charging (when the UE has harvested and stored sufficient energy and there is data transmission) cycle, connected mode (e.g. radio resource control, RRC, connected mode) can be maintained. The signaling overhead required in regular switching between connected and disconnected mode is thus reduced.

In other examples, the UE may be unable to communicate with the network as it is using the energy from the energy harvesting device 500 or the energy storage device 504 for other operations, such as performing computation on the application processor (included in the other parts 502, for example) or performing a measurement from a sensor (not shown) that is attached to the device. A gap in the connected mode communication session may also be required to cope with such scenarios.

Note that while the present disclosure is described with respect to NR, it is also applicable to other types of wireless telecommunications networks, for example, enhanced Machine-Type Communication (eMTC) and NarrowBand Internet of Things (NB-IoT).

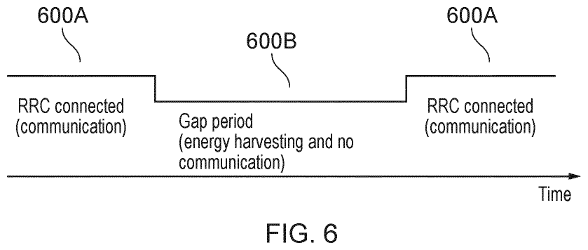

FIG. 6 shows an energy harvesting (EH) gap implemented by a UE according to an embodiment. During a first period 600A, the UE has sufficient stored power and thus communicates with the network. During a second, subsequent period 600B (the EH gap), the UE suspends communication with the network and performs energy harvesting. During the first period 600A of the next cycle, the UE (due to the energy harvesting in the second period 600B) has sufficient power to once again communicate with the network. This alternating communication and charging operation is repeated in a cycle to enable the UE to both regularly communicate with the network and regularly harvest energy, thereby keeping the UE operating effectively.

The charging operation (during the EH gap) may be initiated by the UE itself or by the network (e.g. by an instruction to the UE issued by the gNB). Furthermore, the UE may indicate to the gNB that the UE needs to perform the charging operation. The gNB can then grant the operation based on the indication.

An EH gap may be initiated in response to one or more triggers.

In an example, the trigger is the energy level of the device being below a certain threshold. The threshold is set at a level (e.g. 10% of the total energy storage capacity) to indicate that the device is about to run out of energy. The energy level of the device may be measured, for example, in joules of energy or coulombs of charge stored in the energy storage device 504. The energy level may be defined in absolute terms (e.g. the number of joules or coulombs) or relative terms (e.g. as a percentage of total energy storage capacity).

In an example, the trigger is the required transmission power level associated with the UE power class exceeding a certain threshold. Energy is depleted more rapidly if the UE has to transmit at a higher power level. Thus, for example, if the UE is going to have to transmit a significant number of messages at a high power level, the UE will need an EH gap at some point during the transmission.

In an example, the trigger is the coverage level and/or strength or quality of signals received by the UE from the network (e.g. as measured by the received signal reference power (RSRP) or received signal reference quality (RSRQ)) falling below a certain threshold. For example, when signal strength and/or quality is lower than the threshold, the UE may need to transmit a signal with a higher transmission power and/or repeat transmission of the signal a plurality of times. Thus, an EH gap may be required to ensure the UE has enough energy to do this.

In an example, the trigger is based on a rate of energy consumption or rate of stored energy depletion. For example, the UE may indicate an initial energy level and expected rate of energy depletion. This allows the gNB to adjust its scheduling accordingly and to provide an EH gap where necessary (the trigger thus being, for example, the expiry of a time period of energy consumption at a given expected rate which indicates the UE is about to run out of power). This information (e.g. an initial energy level and expected rate of energy depletion) can be explicitly indicated to the gNB by the UE in advance, thereby allowing the gNB to allocate an EH-gap (in which it does not communicate with the UE) at the appropriate time without needing to receive a further indication from the UE.

Use of two or more of the above triggers may combined. For example, there may be a formula based on two or more of the above triggers and, when an output of the formula exceeds or falls below a defined threshold, this is what initiates the EH gap. For example, the triggers of the device energy level and required transmission power level may be used in combination so an EH gap is only initiated for a higher required transmission power level if the device energy level is below a defined threshold associated with that higher required transmission power level.

In an example, when the above trigger(s) are detected by the UE, an indication is sent to the gNB in response to the detected trigger. UE indication messages to the gNB may therefore be sent aperiodically in this example. This indication can be, for example, a simple 1 bit indication transmitted as a UCI (uplink control information) in a periodically occurring PUCCH (physical uplink control channel) resource that has been configured for the UE or transmitted as a PRACH (physical random access channel) using a known sequence. Alternatively, or additionally, this indication can be a message in a PUSCH (physical uplink shared channel) in which case the UE may have to send an SR (scheduling request) to request for PUSCH resources.

An EH gap may be initiated specifically by the gNB in one or more of the following example scenarios.

In an example, the gNB initiates the EH gap based on the required UE transmission power level, the current energy level of the UE (which may be signaled to the gNB by the UE) and the number of messages that need to be transmitted to and/or received from the UE during a signaling exchange. The gNB can then determine whether the UE has sufficient energy to complete the signaling exchange. If the UE is determined to not have sufficient energy, the gNB can send an instruction to the UE assigning an EH gap.

In an example, the gNB initiates the EH gap based on the coverage level and/or strength or quality of signals received by the UE (e.g. as measured by RSRP or RSRQ), the energy level of the UE (which may be signaled to the gNB by the UE) and the number of messages that need to be transmitted to and/or received from the UE during a signaling exchange. The gNB can then determine whether the UE has sufficient energy to complete the signaling exchange. If the UE is determined to not have sufficient energy, the gNB can send an instruction to the UE assigning an EH gap.

The UE may determine assistance data related to the required EH gap duration and, if necessary, provide it to the gNB.

In an example, the assistance data indicates the required time duration of the EH gap (EH gap time) for charging the energy storage device 504.

This may vary depending on, for example, what the UE is used for. For example, a UE transmitting small amounts of sensor data requires less stored energy. Charging (at a given charging rate) can thus occur more quickly and the required EH gap time is therefore shorter. On the other hand, a UE transmitting large amounts of video data requires more stored energy. Charging (at the same given charging rate) thus occurs more slowly and the required EH gap time is therefore longer. It may also vary depending on, for example, the ambient energy available. For example, on a cloudy day the time needed to harvest solar energy may be longer (and therefore a longer EH gap time is required) than on a sunny day.

In an example, the assistance data indicates the required EH gap time to achieve a threshold stored energy level. For example, the assistance data may indicate the required EH gap duration to achieve 50% of the energy storage potential of the device. More particularly, the assistance data may indicate the required EH gap times to achieve different threshold stored energy levels. For example, the assistance data could indicate (1) the EH gap time required to achieve 50% energy and (2) the EH gap time required to achieve 100% energy.

In an example, the assistance data indicates the required EH gap time to harvest sufficient energy to complete a defined message exchange with the gNB. For example, the gNB may signal it requires to transfer a defined amount of data (e.g. 1000 bytes) with the UE. Based on this (together with predefined information such as the total energy storage capacity of the energy storage device 504, the amount of energy required to exchange a given amount of data and the available EH charge rate), the UE may then calculate how many EH gaps will be required and the duration of each EH gap. The UE may then signal this information to the gNB.

In an example, the UE itself may know the expected message exchange with the gNB. The UE is therefore able to determine the number and duration of EH gaps and, once determined, signal these to the gNB. The UE may know details of the expected message exchange for various reasons.

One example reason is that the UE has a fixed application. For example, the UE may be a temperature sensor and its function is to transmit temperature readings to an application server. In this case, the message exchange is known and predictable.

Another example reason is that the application server indicates details of the expected message exchange to the UE. For instance, the UE can run two applications (e.g. a temperature measurement application, entailing a known 100-byte message exchange, and a camera application, entailing a known 100000-byte message exchange) and the application server indicates which application is being run at the start of a message exchange with the UE. Based on the indicated application, the UE is thus able to determine the expected message exchange (in particular, the amount of data exchanged in the message exchange) and determine the number and duration of required EH gaps during the message exchange accordingly.

In an example, a UE may require communication with the gNB to be stopped during an energy harvesting period. For example, a UE may be unable to both communicate and harvest energy during an EH gap if the power required to communicate is greater than the power available from the energy harvesting source. Alternatively, if sufficient energy can be stored in the UE's energy storage device 504, the UE may be able to concurrently perform communication and energy harvesting. However, if the power required to communicate is greater than the power available from the energy harvesting source, this will eventually lead to depletion of the energy storage device 504. Use of an EH gap is thus desirable in either scenario.

In an example, the assistance data indicates the rate of energy consumption and/or rate of depletion of stored energy (these may be different if, for example, the modem 503 is powered by power flows B and C). This may be used (together with an initial stored charge amount, which may also be transmitted in the assistance data, for example) by the gNB to initiate an EH gap after an appropriate time period in the way previously described.

In an example, the gNB provides configuration information to support the UE's EH gap operation. This can be broadcasted to the UE, for example, to support energy harvesting. This may include, for example, the stored energy level threshold at which energy harvesting occurs. It may also include whether the gNB is able to support UEs requiring an EH gap operation or not.

In an example, the gNB provides information to the UE indicating details of the EH gap. This can be based on the UE assistance data. The indicated details of the EH gap can include, for example, the granted EH gap duration (e.g. in seconds, in number of SFN (system frame number) or in number of HFN (hyper frame number)), the granted EH gap pattern (e.g. the number of EH gaps, the duration of each EH gap and the time between successive EH gaps), the minimum energy level that should be obtained by the device during the EH gap, the EH gap periodicity (for scenarios where the EH gap is provided periodically, e.g. in cases where the traffic is periodic and known and the availability of energy harvesting opportunities are predictable) and/or the expected UE state after the gap (e.g. maintain RRC connected mode or enter inactive/idle mode).

The configuration information and/or EH details information may be provided to the UE in any appropriate way. For example, it may be broadcast (e.g. in the case of cell-specific configuration and/or EH details information) or may be signaled to the UE in a unicast manner at the start of an RRC connection (e.g. in the case of UE-specific configuration and/or EH details information). For example, the gNB could indicate the EH gap duration via broadcast signaling and then enable those gaps by unicast signaling. This enabling signaling could take the form of a simple 1-bit indication that the EH gap is assigned, for example. In response to receiving the enabling signaling, the UE can then recover details of the EH gap from configuration information and/or EH details information that was previously broadcast or previously sent in unicast signaling.

Once the gNB grants the EH gap (e.g. via the enabling signaling bit), the UE undertakes the energy harvesting at a given time that can be implicitly or explicitly indicated to the UE. In an example of implicit indication, the relevant specification(s) specifies that the EH gap starting time is a predetermined time period after the reception of the EH grant. In an example of explicit indication, the gNB explicitly informs the UE when the UE should deploy the EH gap. This information can be sent at the same time as the gNB providing the EH grant (e.g. as additional information provided with the enabling signaling bit indicating a defined time period after receipt of the enabling signaling bit at which the EH gap is to begin).

In an example, the UE is in an RRC state prior to the EH gap and is assumed to maintain that RRC state after the EH gap and to have fulfilled the minimum energy level that the UE should obtain during the EH gap (as indicated by the EH details information, for example). For example, if, prior to the EH gap, the UE is in an RRC connected state then, after the EH gap, the UE will continue to be in that RRC connected state. If for some reason the UE is unable to fulfil the minimum energy level (e.g. due to the available harvestable energy being insufficient), the UE assumes that it (the UE) is henceforth disconnected from the network and may continue to charge the battery (in effect unilaterally extending the EH gap). The network may not be able to reach the device and, in such a case, the network assumes the device is disconnected.

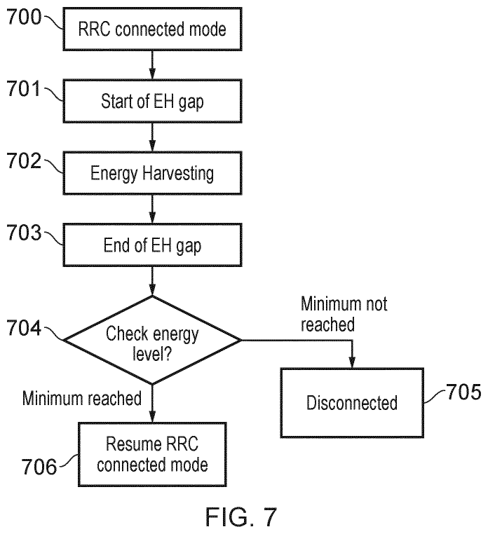

This is exemplified in FIG. 7, which shows a process carried out by the UE. At step 700, the UE enters RRC connected mode. At step 701, based on an EH grant from the network, the EH gap is started. At step 702, during the EH gap, the UE harvests energy. At step 703, the end of the EH gap is reached. At step 704, the UE checks the stored energy level and determines whether the minimum energy level that should be obtained by the UE during the EH gap (e.g. as signaled in the EH details information) has been reached. If the minimum has been reached, the process proceeds to step 706 in which RRC connected mode is maintained with the network. If the minimum has not been reached, the process proceeds to step 705 and the UE disconnects from the network to continue harvesting energy. Thus, as long as the UE is able to obtain the specified minimum energy level in the EH gap, the RRC connection with the network is maintained. The signaling overhead required to connect and disconnect the UE from RRC connected mode is thus reduced.

In an example, the UE can start an EH gap autonomously following an indication to the gNB. For example, the UE can indicate to the gNB that it is in a low energy state (e.g. the UE has less than a first threshold of remaining energy, e.g. 10% remaining energy). This may be referred to as a low energy alert signal. The UE can then continue communicating until it runs out of charge/energy (or until it falls to less than an even lower of second threshold remaining energy, e.g. 2% remaining energy). Having run out of energy, the UE then enters an EH gap to replenish its energy (the length of which is known to the gNB due to being defined in the relevant specification(s) or being indicated by the UE when it reports it is in a low energy state, for example). The gNB is not signaled again when the UE has entered into the EH gap state, but knows from the previous signaling (indicating the UE is in a low energy state) and the fact the UE is no longer responding the gNB that the UE is in the EH gap state. For example, the gNB may assign the UE with physical uplink shared channel (PUSCH) resources, but the gNB will detect no UE transmission on the assigned PUSCH resources (since the UE is in an EH gap and is therefore not making any transmission). Since the gNB does not receive the PUSCH (and since the UE will have recently sent the low energy indication), the gNB is able to determine that the UE must have entered an EH gap. The gNB thus waits for a time based on the duration of the EH gap before once again attempting to communicate with the UE. In an example, the gNB may not know exactly when the UE started its EH gap. However, the gNB wait time is selected such that the time at which the gNB once again attempts communication with the UE is known to lie beyond the end of the EH gap. For example, when the gNB stops receiving transmission from the UE (indicating the UE has entered the EH gap), the gNB may start a timer and not attempt communication with the UE again until a time period which is a certain percentage longer than the known EH gap duration (e.g. 50% longer) to account for the uncertainty in the EH gap start time.

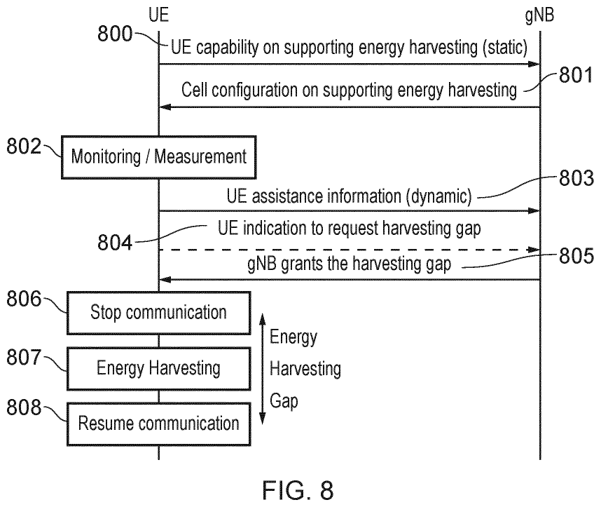

FIG. 8 shows an example signaling exchange between a UE and a gNB. At step 800, the UE reports its capability on supporting energy harvesting (e.g. it indicates whether or not it supports energy harvesting) and optionally reports the harvesting source/type. At step 801, the gNB indicates, in one or more configuration signals, the configuration information and/or EH details information to the UE. At step 802, the UE enters RRC connected mode with the gNB and performs the usual monitoring and measurement of radio signals associated with RRC connected mode. It also monitors its stored energy level. At step 803, the UE transmits assistance data (e.g. indicating the EH gap duration, rate of stored energy depletion and current stored energy level) to the gNB. Optionally, at step 804, when the stored energy level falls below a threshold, the UE sends the gNB a request for an EH gap. This step may not be required if, for example, the gNB itself determines when the stored energy level will have fallen below the threshold based on the stored energy level and stored energy depletion rate indicated in the assistance data at step 803. At step 805, the gNB grants the EH gap. This may be referred to as an initial signal since it initiates the EH gap. At step 806, the UE stops communication with the gNB. At step 807, the UE enters the EH gap. At step 808, after the EH gap, the UE resumes communication with the gNB.

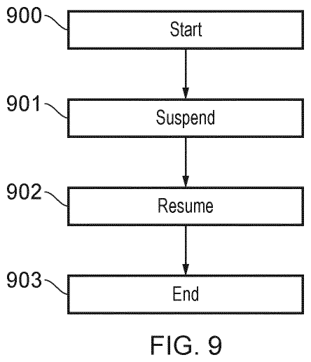

FIG. 9 shows a method carried out by a first wireless telecommunications apparatus (e.g. a UE such as device 501) according to an embodiment. The first wireless telecommunications apparatus has communication circuitry (e.g. comprised in modem 503) configured to receive wireless signals from or transmit wireless signals to a second wireless telecommunications apparatus (e.g. TRP 10, which may be a gNB), the communication circuitry using energy stored in an energy storage device (e.g. energy storage device 504) to receive or transmit the wireless signals. The first wireless telecommunications apparatus also has control circuitry (e.g. comprised in a processor of the other parts 502 or in modem 503).

The method starts at step 900.

At step 901, the control circuitry controls the communication circuitry to suspend the receiving of wireless signals from or transmitting of wireless signals to the second wireless telecommunications apparatus during a time period when there is insufficient energy in the energy storage device usable by the communication circuitry.

At step 902, the control circuitry controls the communication circuitry to resume the receiving of wireless signals from or transmitting of wireless signals to the second wireless telecommunications apparatus after a time period of accumulating sufficient energy in the energy storage device (e.g. by energy harvesting) usable by the communication circuitry.

The method ends at step 903.

In an example, during the suspension of receiving or transmitting wireless signals (step 901), there may be some energy remaining in the energy storage device to power other component(s) of the first wireless telecommunications apparatus. Alternatively, or in addition, energy harvesting can be used to power such alternative component(s). In this case, the harvested energy may be used to power the alternative component(s) at the same time as or before being used to charge the energy storage device.

An example alternative component powered by remaining energy stored in the energy storage device and/or harvested energy is a sensor (not shown) connected to the first wireless telecommunications apparatus (e.g. comprised within the first wireless telecommunications apparatus). The sensor may be any type of sensor, for example, a temperature sensor, pressure sensor, light sensor or the like. During the time of suspension of receiving or transmitting wireless signals, the control circuitry continues to use available energy (e.g. stored or harvested) to obtain measurement(s) from the sensor.

An example alternative component powered by remaining energy stored in the energy storage device and/or harvested energy is an application processor (e.g. comprised in other parts 502) connected to the first wireless telecommunications apparatus (e.g. comprised within the first wireless telecommunications apparatus). During the time of suspension of receiving or transmitting wireless signals, the control circuitry continues to use available energy (e.g. stored or harvested) to operate the application processor and/or modem processor.

In an example, there is insufficient energy in the energy storage device usable by the communication circuitry when there is insufficient energy for the communication circuitry to perform its normal operation. Normal operation means, for example, the communication circuitry is able to carry out every function it is configured to carry out. This includes, for example, both transmitting and receiving wireless signals (together with carrying out any necessary encoding or decoding on the transmitted and received wireless signals). When there is insufficient energy usable by the communication circuitry, this means there is insufficient energy for at least one function the communication circuitry is configured to carry out to be carried out.

For example, it may be there is insufficient energy for the communication circuitry to transmit wireless signals and therefore the communication circuitry is able to receive wireless signals only. In this example, during the time of suspension, the control circuitry continues to use available energy (e.g. stored or harvested) to allow the communication circuitry to receive wireless signals only. In an example, there may only be sufficient available energy (e.g. stored or harvested) for the communication circuitry to perform basic operation(s) on received wireless signals. For example, such basic operation(s) may include performing measurements(s) on received wireless signals (e.g. measuring signal strength or quality, respectively measured using reference signal received power (RSRP) and reference signal received quality (RSRQ)) but performing no further operations. In another example, such basic operation(s) may include performing time/frequency synchronization (e.g. reception of synchronization signal block (SSB) and/or maintaining the clock of the device.

This provides improved flexibility on how available energy (e.g. stored or harvested) is used. For example, if the energy left in the battery of UE is low, the UE may use the time period in which communication is suspended to do a sensor measurement using harvested energy rather than to accumulate energy in the battery. When the UE has a lot of energy in the battery, it can simultaneously communicate and do sensor measurements (and thus communication is not suspended). However, when the UE has a low battery, it may be beneficial to conserve the little energy remaining in the battery in case it is needed (e.g. for a final communication before the battery is completely depleted). Thus, it uses harvested energy to continue to obtain sensor measurements rather than to accumulate energy in the battery. Communication is then only resumed once, for example, there is sufficient harvestable energy to both continue obtaining sensor measurements and accumulate sufficient charge in the battery. Such an example could be applied, for example, to solar energy harvesting. When there is insufficient energy stored in the battery and it is cloudy (and therefore there is less solar energy available), the small amount of energy which is harvested is used to power the circuitry required to obtain sensor measurements rather than to charge the battery. However, if it then becomes sunny (and therefore there is more solar energy available), the larger amount of energy which is harvested can be used to both power the circuitry required to obtain sensor measurements and charge the battery. When the battery is sufficiently charged to allow normal communication again, normal communication is resumed.

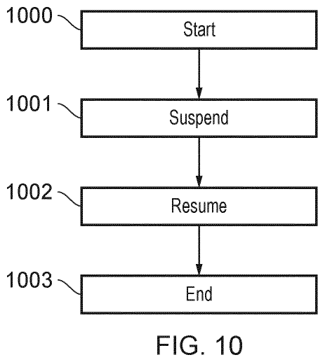

FIG. 10 shows a method carried out by a first wireless telecommunications apparatus (e.g. TRP 10, which may be a gNB) according to an embodiment. The first wireless telecommunications apparatus has communication circuitry (e.g. comprised in transmitter 30 and/or receiver 32) configured to receive wireless signals from or transmit wireless signals to a second wireless telecommunications apparatus (e.g. a UE such as device 501), the second wireless telecommunications apparatus using energy stored in an energy storage device (e.g. energy storage device 504) to receive or transmit the wireless signals. The first wireless telecommunications apparatus also has control circuitry (e.g. comprised in controller 34).

The method starts at step 1000.

At step 1001, the control circuitry controls the communication circuitry to suspend the receiving of wireless signals from or transmitting of wireless signals to the second wireless telecommunications apparatus during a time period when there is insufficient energy in the energy storage device usable by the second wireless telecommunications apparatus to transmit or receive the wireless signals.

At step 1002, the control circuitry controls the communication circuitry to resume the receiving of wireless signals from or transmitting of wireless signals to the second wireless telecommunications apparatus after a time period of accumulating sufficient energy in the energy storage device (e.g. by energy harvesting) usable by the second wireless telecommunications apparatus to transmit or receive the wireless signals.

The method ends at step 1003.

The present disclosure thus allows UEs to be able to harvest energy whilst alleviating the need to regularly switch between connected and disconnected mode. UEs, in particular low power UEs, are therefore able to communicate with a network reliably and with reduced signaling overhead.

Embodiment(s) of the present disclosure are defined by the following numbered clauses:

1. A first wireless telecommunications apparatus comprising:
communication circuitry configured to receive wireless signals from or transmit wireless signals to a second wireless telecommunications apparatus, the communication circuitry using energy stored in an energy storage device to receive or transmit the wireless signals; and
control circuitry configured to:
control the communication circuitry to suspend the receiving of wireless signals from or transmitting of wireless signals to the second wireless telecommunications apparatus during a time period when there is insufficient energy in the energy storage device usable by the communication circuitry; and
control the communication circuitry to resume the receiving of wireless signals from or transmitting of wireless signals to the second wireless telecommunications apparatus after a time period of accumulating sufficient energy in the energy storage device usable by the communication circuitry.
   2. A first wireless telecommunications apparatus according to clause 1, wherein the suspending of the receiving of wireless signals from or transmitting of wireless signals to the second wireless telecommunications apparatus is initiated when an amount of energy stored in the energy storage device is below a threshold.
   3. A first wireless telecommunications apparatus according to any preceding clause wherein the suspending of the receiving of wireless signals from or transmitting of wireless signals to the second wireless telecommunications apparatus is initiated in response to an initiation signal received from the second wireless telecommunications apparatus.
   4. A first wireless telecommunications apparatus according to clause 3 wherein the initiation signal is received in response to a request signal transmitted to the second wireless telecommunications apparatus, the control circuitry being configured to control the communication circuitry to transmit the request signal when an amount of energy stored in the energy storage device is below a threshold.
   5. A first wireless telecommunications apparatus according to clause 3 wherein the control circuitry is configured to control the communication circuitry to transmit an assistance signal comprising assistance data to the second wireless telecommunications apparatus, the assistance data being usable by the second wireless telecommunications apparatus to determine when to send the initiation signal.
   6. A first wireless telecommunications apparatus according to clause 5 wherein the assistance data comprises one or more of a current amount of energy stored in the energy storage device, a rate of depletion of energy stored in the energy storage device, a rate of consumption of energy of the first wireless telecommunications apparatus and a required duration of the time period of accumulating sufficient energy in the energy storage device usable by the communication circuitry.
   7. A first wireless telecommunications apparatus according to clause 1 wherein:
the control circuitry is configured to control the communication circuitry to transmit an alert signal to the second telecommunications apparatus when an amount of energy stored in the energy storage device is below a first threshold; and
the suspending of the receiving of wireless signals from or transmitting of wireless signals to the second wireless telecommunications apparatus is initiated when an amount of energy stored in the energy storage device is below a second threshold, the second threshold being lower than the first threshold.
   8. A first wireless telecommunications apparatus according to any preceding clause wherein the control circuitry is configured to control the first wireless telecommunications apparatus to remain in a connected mode with the second wireless telecommunications apparatus during the suspending of the receiving of wireless signals from or transmitting of wireless signals to the second wireless telecommunications apparatus.
   9. A first wireless telecommunications apparatus according to clause 8 wherein the control circuitry is configured to:
determine, after the time period of accumulating energy in the energy storage device, if an amount of energy stored in the energy storage device is above a threshold;
if the amount of energy stored in the energy storage device is above the threshold, control the first wireless telecommunications apparatus to remain in the connected mode with the second wireless telecommunications apparatus; and
if the amount of energy stored in the energy storage device is not above the threshold, control the first wireless telecommunications apparatus to transition from the connected mode to a disconnected mode.
   10. A first wireless telecommunications apparatus according to any preceding clause, wherein the control circuitry is configured to control the communication circuitry to transmit a capability signal to the second wireless telecommunications apparatus indicating an ability of the first wireless telecommunications apparatus to suspend receiving of wireless signals from or transmission of wireless signals to the second wireless telecommunications apparatus.
   11. A first wireless telecommunications apparatus according to any preceding clause wherein:
the first wireless telecommunications apparatus is connected to a sensor; and
during the time when there is insufficient energy in the energy storage device usable by the communication circuitry, the control circuitry is configured to use available energy to obtain a measurement from the sensor.
   12. A first wireless telecommunications apparatus according to any preceding clause wherein:
the first wireless telecommunications apparatus is connected to an application processor; and
during the time when there is insufficient energy in the energy storage device usable by the communication circuitry, the control circuitry is configured to use available energy to operate the application processor.
   13. A first wireless telecommunications apparatus according to any preceding clause wherein, during the time when there is insufficient energy in the energy storage device usable by the communication circuitry, the control circuitry is configured to control the communication circuitry to receive wireless signals for measurement only.
   14. A first wireless telecommunications apparatus according to any preceding clause wherein, during the time when there is insufficient energy in the energy storage device usable by the communication circuitry, the control circuitry is configured to perform time and/or frequency synchronization and/or to maintain a clock of the first wireless telecommunications apparatus.
   15. A first wireless telecommunications apparatus comprising:
communication circuitry configured to receive wireless signals from or transmit wireless signals to a second wireless telecommunications apparatus, the second wireless telecommunications apparatus using energy stored in an energy storage device to transmit or receive the wireless signals; and
control circuitry configured to:
control the communication circuitry to suspend the receiving of wireless signals from or transmitting of wireless signals to the second wireless telecommunications apparatus during a time period when there is insufficient energy in the energy storage device usable by the second wireless telecommunications apparatus to transmit or receive the wireless signals; and
control the communication circuitry to resume the receiving of wireless signals from or transmitting of wireless signals to the second wireless telecommunications apparatus after a time period of accumulating sufficient energy in the energy storage device usable by the second wireless telecommunications apparatus to transmit or receive the wireless signals.
   16. A first wireless telecommunications apparatus according to clause 15, wherein the suspending of the receiving of wireless signals from or transmitting of wireless signals to the second wireless telecommunications apparatus is initiated when an amount of energy stored in the energy storage device is below a threshold.
   17. A first wireless telecommunications apparatus according to clause 15 or 16 wherein the control circuitry is configured to control the communication circuitry to transmit an initiation signal to the second wireless telecommunications apparatus to initiate the suspending of the receiving of wireless signals from or transmitting of wireless signals to the second wireless telecommunications apparatus.
   18. A first wireless telecommunications apparatus according to clause 17 wherein the initiation signal is transmitted in response to a request signal received from the second wireless telecommunications apparatus.
   19. A first wireless telecommunications apparatus according to clause 17 wherein the control circuitry is configured to determine when to control the communication circuitry to send the initiation signal using assistance data comprised in an assistance signal received from the second wireless telecommunications apparatus.
   20. A first wireless telecommunications apparatus according to clause 19 wherein the assistance data comprises one or more of a current amount of energy stored in the energy storage device, a rate of depletion of energy stored in the energy storage device, a rate of consumption of energy of the second wireless telecommunications apparatus and a required duration of the time period of accumulating sufficient energy in the energy storage device usable by the second wireless telecommunications apparatus to transmit or receive the wireless signals.
   21. A first wireless telecommunications apparatus according to clause 15 wherein:
the control circuitry is configured to control the communication circuitry to receive an alert signal from the second telecommunications apparatus, the alert signal being transmitted by the second telecommunications apparatus when an amount of energy stored in the energy storage device is below a threshold; and
the suspending of the receiving of wireless signals from or transmitting of wireless signals to the second wireless telecommunications apparatus is initiated when wireless signals transmitted by the second wireless telecommunications apparatus are not detectable by the communication circuitry.
   22. A first wireless telecommunications apparatus according to any one of clauses 15 to 21 wherein the control circuitry controls the first wireless telecommunications apparatus to remain in a connected mode with the second wireless telecommunications apparatus during the suspending of the receiving of wireless signals from or transmitting of wireless signals to the second wireless telecommunications apparatus.
   23. A first wireless telecommunications apparatus according to any one of clauses 15 to 22, wherein the control circuitry is configured to control the communication circuitry to transmit a configuration signal to the second wireless telecommunications apparatus to support the suspending of receiving of wireless signals from or transmission of wireless signals to the second wireless telecommunications apparatus.
   24. A method of controlling a first wireless telecommunications apparatus, the first wireless telecommunications apparatus comprising communication circuitry configured to receive wireless signals from or transmit wireless signals to a second wireless telecommunications apparatus, the communication circuitry using energy stored in an energy storage device to receive or transmit the wireless signals, wherein the method comprises:
controlling the communication circuitry to suspend the receiving of wireless signals from or transmitting of wireless signals to the second wireless telecommunications apparatus during a time period when there is insufficient energy in the energy storage device usable by the communication circuitry; and
controlling the communication circuitry to resume the receiving of wireless signals from or transmitting of wireless signals to the second wireless telecommunications apparatus after a time period of accumulating sufficient energy in the energy storage device usable by the communication circuitry.
   25. A method of operating a first wireless telecommunications apparatus, the first wireless telecommunications apparatus comprising communication circuitry configured to receive wireless signals from or transmit wireless signals to a second wireless telecommunications apparatus, the second wireless telecommunications apparatus using energy stored in an energy storage device to transmit or receive the wireless signals, wherein the method comprises:
controlling the communication circuitry to suspend the receiving of wireless signals from or transmitting of wireless signals to the second wireless telecommunications apparatus during a time period when there is insufficient energy in the energy storage device usable by the second wireless telecommunications apparatus to transmit or receive the wireless signals; and
controlling the communication circuitry to resume the receiving of wireless signals from or transmitting of wireless signals to the second wireless telecommunications apparatus after a time period of accumulating sufficient energy in the energy storage device usable by the second wireless telecommunications apparatus to transmit or receive the wireless signals.
   26. A program for controlling a computer to perform a method according to clause 24 or 25.
   27. A storage medium storing a program according to clause 26.
   28. A wireless telecommunications system comprising a wireless telecommunications apparatus according to clause 1 and a wireless telecommunications apparatus according to clause 15.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a machine-readable medium (in particular, a non-transitory machine-readable medium) carrying such software, such as an optical disk, a magnetic disk, semiconductor memory or the like, is also considered to represent an embodiment of the present disclosure. In particular, the present disclosure should be understood to include a non-transitory storage medium comprising code components which cause a computer to perform any of the disclosed method(s).

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

### REFERENCES

[1] Holma H. and Toskala A, “LTE for UMTS OFDMA and SC-FDMA based radio access”, John Wiley and Sons, 2009.
[2] D. Ma, G. Lan, M. Hassan, W. Hu and S. K. Das, “Sensing, Computing, and Communications for Energy Harvesting IoTs: A Survey,” in IEEE Communications Surveys & Tutorials, vol. 22, no. 2, pp. 1222-1250, Secondquarter 2020

1. A first wireless telecommunications apparatus comprising:
communication circuitry configured to receive wireless signals from or transmit wireless signals to a second wireless telecommunications apparatus, the communication circuitry using energy stored in an energy storage device to receive or transmit the wireless signals; and
control circuitry configured to:
control the communication circuitry to suspend the receiving of wireless signals from or transmitting of wireless signals to the second wireless telecommunications apparatus during a time period when there is insufficient energy in the energy storage device usable by the communication circuitry; and
control the communication circuitry to resume the receiving of wireless signals from or transmitting of wireless signals to the second wireless telecommunications apparatus after a time period of accumulating sufficient energy in the energy storage device usable by the communication circuitry.

2. A first wireless telecommunications apparatus according to claim 1, wherein the suspending of the receiving of wireless signals from or transmitting of wireless signals to the second wireless telecommunications apparatus is initiated when an amount of energy stored in the energy storage device is below a threshold.

3. A first wireless telecommunications apparatus according to claim 1 wherein the suspending of the receiving of wireless signals from or transmitting of wireless signals to the second wireless telecommunications apparatus is initiated in response to an initiation signal received from the second wireless telecommunications apparatus.

4. A first wireless telecommunications apparatus according to claim 3 wherein the initiation signal is received in response to a request signal transmitted to the second wireless telecommunications apparatus, the control circuitry being configured to control the communication circuitry to transmit the request signal when an amount of energy stored in the energy storage device is below a threshold.

5. A first wireless telecommunications apparatus according to claim 3 wherein the control circuitry is configured to control the communication circuitry to transmit an assistance signal comprising assistance data to the second wireless telecommunications apparatus, the assistance data being usable by the second wireless telecommunications apparatus to determine when to send the initiation signal.

6. A first wireless telecommunications apparatus according to claim 5 wherein the assistance data comprises one or more of a current amount of energy stored in the energy storage device, a rate of depletion of energy stored in the energy storage device, a rate of consumption of energy of the first wireless telecommunications apparatus and a required duration of the time period of accumulating sufficient energy in the energy storage device usable by the communication circuitry.

7. A first wireless telecommunications apparatus according to claim 1 wherein:
the control circuitry is configured to control the communication circuitry to transmit an alert signal to the second telecommunications apparatus when an amount of energy stored in the energy storage device is below a first threshold; and
the suspending of the receiving of wireless signals from or transmitting of wireless signals to the second wireless telecommunications apparatus is initiated when an amount of energy stored in the energy storage device is below a second threshold, the second threshold being lower than the first threshold.

8. A first wireless telecommunications apparatus according to claim 1 wherein the control circuitry is configured to control the first wireless telecommunications apparatus to remain in a connected mode with the second wireless telecommunications apparatus during the suspending of the receiving of wireless signals from or transmitting of wireless signals to the second wireless telecommunications apparatus.

9. A first wireless telecommunications apparatus according to claim 8 wherein the control circuitry is configured to:
determine, after the time period of accumulating energy in the energy storage device, if an amount of energy stored in the energy storage device is above a threshold;
if the amount of energy stored in the energy storage device is above the threshold, control the first wireless telecommunications apparatus to remain in the connected mode with the second wireless telecommunications apparatus; and
if the amount of energy stored in the energy storage device is not above the threshold, control the first wireless telecommunications apparatus to transition from the connected mode to a disconnected mode.

10. A first wireless telecommunications apparatus according to claim 1, wherein the control circuitry is configured to control the communication circuitry to transmit a capability signal to the second wireless telecommunications apparatus indicating an ability of the first wireless telecommunications apparatus to suspend receiving of wireless signals from or transmission of wireless signals to the second wireless telecommunications apparatus.

11. A first wireless telecommunications apparatus according to claim 1 wherein:
the first wireless telecommunications apparatus is connected to a sensor; and
during the time when there is insufficient energy in the energy storage device usable by the communication circuitry, the control circuitry is configured to use available energy to obtain a measurement from the sensor.

12. A first wireless telecommunications apparatus according to claim 1 wherein:
the first wireless telecommunications apparatus is connected to an application processor; and
during the time when there is insufficient energy in the energy storage device usable by the communication circuitry, the control circuitry is configured to use available energy to operate the application processor.

13. A wireless telecommunications apparatus according to claim 1 wherein, during the time when there is insufficient energy in the energy storage device usable by the communication circuitry, the control circuitry is configured to control the communication circuitry to receive wireless signals for measurement only.

14. A first wireless telecommunications apparatus according to claim 1 wherein, during the time when there is insufficient energy in the energy storage device usable by the communication circuitry, the control circuitry is configured to perform time and/or frequency synchronization and/or to maintain a clock of the first wireless telecommunications apparatus.

15.-23. (canceled)

24. A method of controlling a first wireless telecommunications apparatus, the first wireless telecommunications apparatus comprising communication circuitry configured to receive wireless signals from or transmit wireless signals to a second wireless telecommunications apparatus, the communication circuitry using energy stored in an energy storage device to receive or transmit the wireless signals, wherein the method comprises:
controlling the communication circuitry to suspend the receiving of wireless signals from or transmitting of wireless signals to the second wireless telecommunications apparatus during a time period when there is insufficient energy in the energy storage device usable by the communication circuitry; and
controlling the communication circuitry to resume the receiving of wireless signals from or transmitting of wireless signals to the second wireless telecommunications apparatus after a time period of accumulating sufficient energy in the energy storage device usable by the communication circuitry.

25. A method of operating a first wireless telecommunications apparatus, the first wireless telecommunications apparatus comprising communication circuitry configured to receive wireless signals from or transmit wireless signals to a second wireless telecommunications apparatus, the second wireless telecommunications apparatus using energy stored in an energy storage device to transmit or receive the wireless signals, wherein the method comprises:
controlling the communication circuitry to suspend the receiving of wireless signals from or transmitting of wireless signals to the second wireless telecommunications apparatus during a time period when there is insufficient energy in the energy storage device usable by the second wireless telecommunications apparatus to transmit or receive the wireless signals; and
controlling the communication circuitry to resume the receiving of wireless signals from or transmitting of wireless signals to the second wireless telecommunications apparatus after a time period of accumulating sufficient energy in the energy storage device usable by the second wireless telecommunications apparatus to transmit or receive the wireless signals.

26.-28. (canceled)
